(19) United States
(12) Patent Application Publication
(10) Pub. No.: US 2003/0208634 A1
(43) Pub. Date: Nov. 6, 2003

(54) Method and apparatus for passing pre-processed data to server-side applications

(75) Inventor: Adrian McElligott, Durack (AU)

Correspondence Address: CONLEY ROSE, P.C., P. O. BOX 3267, HOUSTON, TX, 77253-3267, US

(73) Assignee: Geobytes Inc., Reno, NV

(21) Appl. No.: 10/425,381

(22) Filed: Apr. 29, 2003

Related U.S. Application Data
(60) Provisional application No. 60/380,093, filed on May 3, 2002.

(51) Int. Cl. G06F 9/00

(52) U.S. Cl. 709/310

(57) ABSTRACT

A method for passing pre-processed data to server-side applications, where a web-server platform runs a web-server application and one or more server-side applications and the web-server application interacts with said server-side applications by means of an interface separating client-side processes from server-side processes included the step of pre-processing a request from a remote client prior to data from the request being passed to the server-side applications via the interface. Additional data is generated in response to said request at the client-side of said interface. The additional data is made available to the one or more server-side applications in a format according to the interface.

### FIELD OF THE INVENTION

The present invention is concerned with a method for passing information generated in response to a remote browser request to server-side applications. In a particular application the invention is concerned with an improved method of distributing data from an information source to a server-side application. The invention is particularly useful for distributing information pertaining to the client connection to all server-side applications accessing a web-server.

### BACKGROUND TO THE INVENTION

FIG. 1 depicts a typical prior art information flow over the internet between a web-browser 2 running on a client personal computer 3 and a web-server application 8 running on a computer system 7. Typically computer system 7 will include one or more central processing units (CPUs) accessing solidstate and secondary memory devices. The computer system may be entirely located in one location or it may be distributed across a number of different hardware installations with data communications between each hardware installation. Similarly communication between the client personal computer 3 and computer system 7 may be by any type of physical or logical means of connecting computer systems that is known. For purposes of explaining the present invention the connection is typically by means of the Internet. Web-browser 2 is a software program or “application” that facilitates communication between personal computer 3 and other computers, such as computer system 7, over the Internet. Examples of web-browsers include Netscape Navigator, Microsoft Internet Explorer and Apple Computer's CyberDog software products.

Web-browser 2 generates a request 4 which is transmitted to computer system 7 which runs a web-server application 8. Web-server application 8 is a software program that allows a user at client personal computer 3 to access information from server-side applications and data sources available to the web-server. Computer system 7 typically outputs pages of HTML code to web-browser 2 in response to requests 4.

The HTML code output from web-server application 8 may include static HTML pages or may include data that is dynamically determined specifically in response to data derived from browser request 4 and its underlying Internet protocol packet data.

Request 4 typically conforms to a HTTP standard. Web-server application 8 implements a CGI (common gateway interface) to allow data in request 4 to access a server-side application, such as server-side application 18. According to the CGI protocol CGI variables holding values derived from request 4 and underlying internet protocol packets associated with the request include the following: PATH, REMOTE_HOST, REMOTE_ADDR, REQUEST_METHOD and HTTP_*. This last variable, HTTP_*, is reserved for any request information sent by the client that does not fit into any one of the standard variables.

Web-server application 8 determines if it has access to a server-side application appropriate for dealing with the request. If it does, then the appropriate server-side application, e.g. application 18, is called. Server-side application 18 is CGI compliant and so is able to access the CGI variables. The response application may be written in any one of many different script or program language types. For example, server-side applications are most commonly written in PERL but also in ASP, C, C++ and PHP. In order for server-side application 18 to respond to request 4, information may have to be retrieved from an information source 16 which may comprise a repository of server-side data, for example it may be a database. Alternatively, information source 16 might be an application that produces a response according to some algorithm on the basis of information in request 4. Rather than communicating natively with server-side information source 16, which would require highly complex and non-portable coding, server-side application 18 communicates via an interface 17. Interface 17 may be any one of a number of common types as will be explained later.

A use of the system described in FIG. 1 will now be described in the context of an IP address to geographical location resolving web-server system. Such a system determines the approximate geographical location of a remote browser from the IP address in the Internet protocol packets underlying request 4. The web-server system runs a server-side application that generates a HTML document specific to the geographical location of the browser. Further details of such a system are disclosed in WIPO publication WO 01/57695 corresponding to PCT/AU01/00096 to the present applicant and hereby incorporated in its entirety by cross-reference.

Initially web-browser 2 sends an HTTP request 4 to web-server application 8. The web-server reads the request headers and underlying Internet protocol packets incoming from the web-browser. Web-server application 8 passes the incoming data to server application 18 as CGI variables by means of interface 11. The data includes the IP Address of web-browser 2 which is stored in CGI variable REMOTE_ADDR. Web-server 8 also calls the appropriate server-side application 18 to respond to the request. Typically the server executes the server-side application, which is a CGI script, by forking a child process that executes the CGI binary code.

Server-side application 18 generates a request which is transformed by platform specific interface 17 to a format readable by information source 16. The request is for a geographical location corresponding to the IP Address. Information source 16 generates a query response, including the requested geographical location, which is transformed by interface 17 into a format readable by server-side application 18. Application 18 then generates an HTML document 12 incorporating references to the retrieved geographical information. For example, if the geographical location that is retrieved indicates that client PC 3 is in New York, then HTML document 12 might include a message such as “Welcome to Visitors in New York”. Once HTML document 12 has been generated, it is passed from web-server application 18 back via web-server 8 to browser 2. Browser 2 then displays HTML document 12 which is specifically tailored to reflect the geographical location of web-browser 2.

In contrast to the common gateway interface, there is no common platform or language independent way for an application, such as application 18, to connect to and retrieve server-side information from information source 16. Several different types of interface are available. Some popular interfaces, on the Windows platform include: ODBC (open database connectivity), RPC (remote procedure calls), Memory Mapped Files, Named Pipes, Sockets, ODBC Classes, DAO (Data Access Objects), RDO (Remote Data Objects), OLE DB (object-linking and embedding database) and ADO (ActiveX Data Objects). For example, applications that use the ODBC API (application programming interface) can communicate with any relational database for which there is an ODBC driver. It is up to the provider of the database to ensure that the required ODBC driver is available. Similarly applications which make use of the OLE DB will require a DLL (dynamic link library) that implements the database side OLE DB interface and actually communicates with the database.

Once again, it is up to the database vendor to provide the necessary interface component, which in this example comprises a DLL.

It will be realised that the vendor of information source 16 must provide suitable interface software for each platform that is to be supported. For example, if application 18 interfaces by means of ODBC then the vendor of information source application 16 must supply an ODBC driver in order to make the product available. Furthermore, some interfaces, such as the DAO interface, comprise a significant bottleneck that appreciably slows down the performance of application 18 each time a call has to be made to information source 16.

In addition, due to the connectionless architecture of the HTTP protocol, each request incurs significant overhead in re-establishing its connection to the information source. While connection pooling is often utilised to reduce this overhead, each application 18 needs to establish and maintain its own connection, either pooled or otherwise, to information source 16. Each interface brings with it its own security and authentication overhead, native to that interface. Typically an interface will need to be authenticated once for each request, further increasing the performance overhead of the request.

It is an object of the present invention to address one or more of the above problems.

### SUMMARY OF THE INVENTION

According to a first aspect of the present invention, where a web-server platform runs a web-server application and one or more server-side applications wherein the web-server application interacts with said server-side applications by means of an interface separating client-side processes from server-side processes, there is provided a method comprising the steps of:

pre-processing a request from a remote client prior to data from the request being passed to the server-side applications via the interface;

generating additional data in response to said request at the client-side of said interface; and

making available the additional data to the one or more server-side applications in a format according to the interface.

Preferably the pre-processing step comprises running a pre-processing application running on the web-server platform.

Typically the interface will be the common gateway interface (CGI). Alternatively the pre-processing step may comprise running a pre-processing application on a platform distinct from the web-server platform.

In one embodiment the pre-processing step comprises running a preprocessing application on a firewall platform interposed between the remote client and the web-server platform.

Preferably the pre-processing application is an extension of the web-server application.

Alternatively the pre-processing application may be an extension of a firewall application. A further alternative is that the pre-processing application be an extension of a proxy application.

Alternatively the pre-processing application may intercept the request at an operating system level of the web-server platform.

Preferably the pre-processing application generates the additional data by interaction with a data source application. The data source application may be a database.

Alternatively the data source application may generate the additional data without reference to prior stored data.

The pre-processing application may present the additional data to the web-server application as a number of result headers.

In a preferred embodiment the pre-processing step includes the step of retrieving a geographical location from the data source corresponding to a network address associated with the request.

According to a further aspect of the present invention there is provided a computer system for responding to requests from a web-browser, the computer system supporting a web-server application and communicating with one or more server-side applications by means of a common interface, said computer system comprising:

at least one CPU;

at least one memory coupled to the at least one CPU;

a pre-processing application resident in the memory and executed by the at least one CPU, the pre-processing application including instructions to generate additional data on the basis of the request and to make the additional data available to the server-side applications by means of the common interface.

In a preferred embodiment the pre-processing application comprises an extension of the web-server application.

Alternatively the pre-processing application may be configured to intercept the request at an operating system level of the computer system.

Alternatively, the pre-processing application may comprise an extension to a firewall application communicating between the web-server application and the client browser.

The pre-processing application may interact with a data source application. The data source application may comprise a database.

In a preferred embodiment the pre-processing application includes instructions for retrieving a geographical location from the data source corresponding to a network address associated with the request.

According to a further aspect of the present invention there is provided a software program product executable by a processor of a computer network device, the software program product including:

instructions for detection of a client request at a client side of the computer network device, the client request containing data in a request format;

instructions for generating additional data on the basis of information associated with the client request;

instructions for storing the additional data in the request format.

The computer network device may be a computer system running a web-application.

Alternatively the computer network device could be a computer system running a firewall application.

In a preferred embodiment the instructions for generating additional data include instructions for interfacing with an information source application. The data source application may be a database or alternatively it could be an application that produces a response according to some algorithm on the basis of information in the request.

### BRIEF DESCRIPTION OF THE DRAWINGS

FIG. 1 is a block diagram of a prior art arrangement by which a network responds to remote client requests.

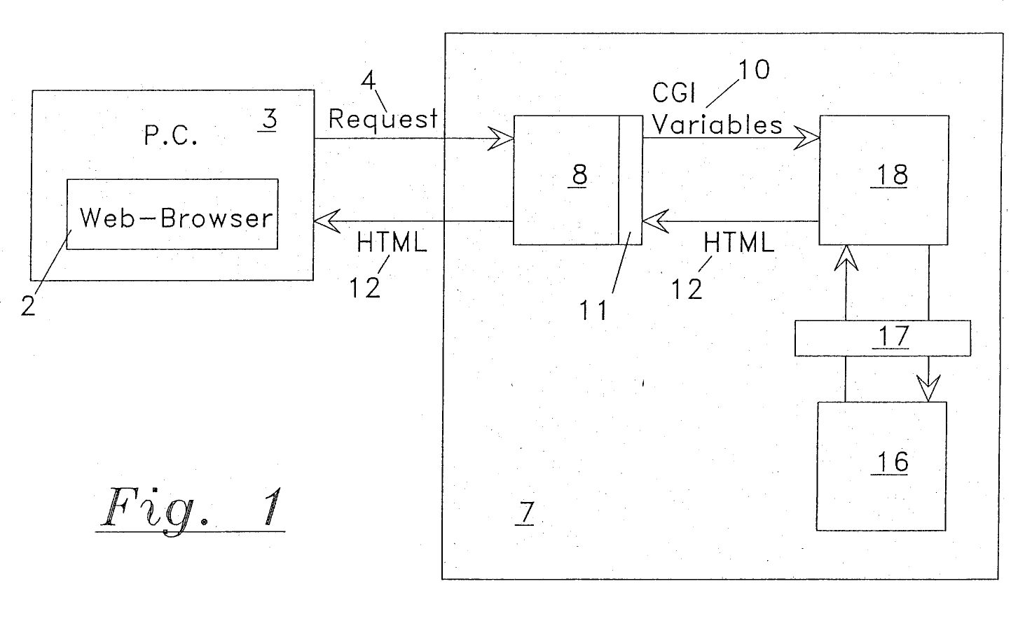

FIG. 2 is a block diagram of an arrangement by which a network server responds to remote client requests according to an embodiment of the present invention.

FIG. 3 is a block diagram of an arrangement by which a computer system responds to remote client requests according to a further embodiment of the present invention.

FIG. 4 is a flowchart of a method according to an embodiment of the present invention.

### DETAILED DESCRIPTION OF PREFERRED EMBODIMENT

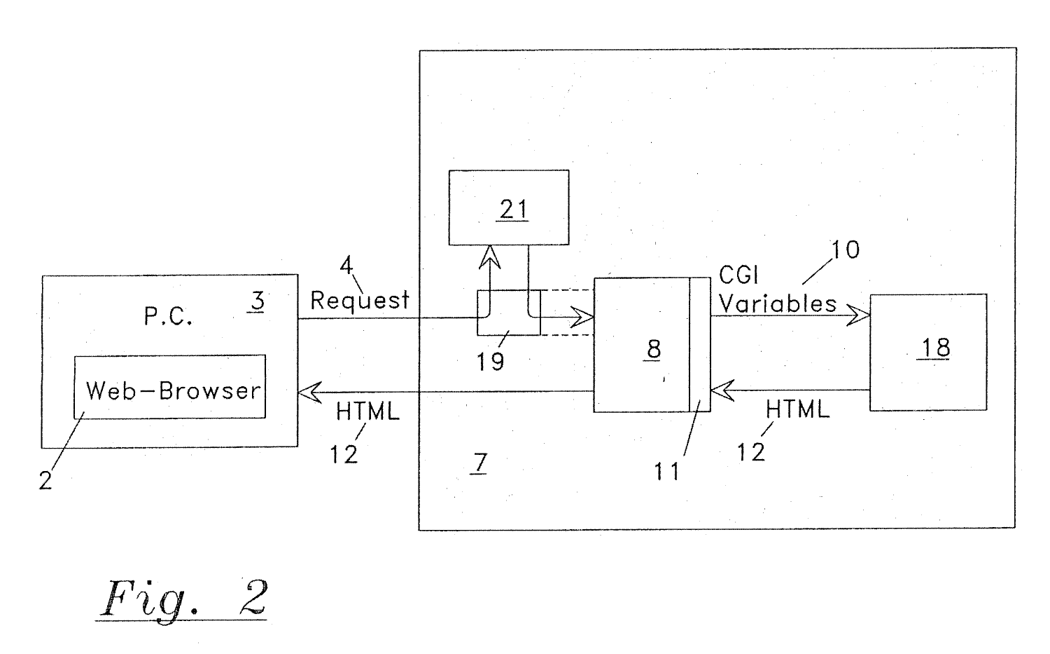

FIG. 2 depicts the arrangement of web-server software modules according to an embodiment of the present invention. In the embodiment shown in FIG. 2 the computer system 7 runs a pre-processing application 19 that communicates with an information source 21. Interface 11, which is typically a CGI compliant interface, facilitates interaction between server side processes, for example processes associated with one or more server-side applications, such as application 18, and client side processes, for example processes running on web-browser 2 side of interface 11. Pre-processing application 21 is preferably a web-server extension and so may be a sub-part of web-server application 8. A vendor supplies both preprocessing application 19 and information source 21 to web sites that wish to make use of the information generated by information source 21. Since server-side applications 18 are generally CGI compliant no matter what their platform, there is no need for the vendor to supply separate interface software modules to the providers and developers of server-side applications.

In use a client web-browser 2 sends a request 4 to web-server application 8. The request is intercepted by pre-processing application 19 which passes data from the request to information source 21. The information source generates response data which is passed back to pre-processing application 19 and inserted as additional data into the request 4. Pre-processing application 19 may integrate directly with web-server application 8 via a custom mechanism provided by each web-server software.

For example, Microsoft IIS call their interface ISAPI, while Netscape call theirs NAPI and Apache refer to theirs as “Apache API”. In an alternative embodiment pre-processing application 19 could be installed to intercept the request at the operating system level of computer system 7. That is, pre-processing application 19 may intercept request 4 and insert additional data before request 4 has been passed to web-server application 8.

In the presently described embodiment, pre-processing application 19 retrieves the IP Address of the web-browser from request 4 and uses the address as a key to retrieve data from information source 21 concerning the geographical location of web-browser 2 and hence PC 3. Pre-processing application 19 then generates a number of result headers. For example the headers may be in the following format.

GeobytesCountryid: 18

GeobytesCountry: Australia

GeobytesFips104: AS

Geobytesiso2: AU

Geobytesiso3: AUS

Geobyteslson: 36

Geobytesinternet: AU

GeobytesRegionid: 3

GeobytesRegion: Queensland

GeobytesCode:

GeobytesAdm1 Code: AS04

GeobytesCityid: 1268

GeobytesCity: Brisbane

GeobytesLatitude: −27.5000

GeobytesLongitude: 153.0170

GeobytesTimeZone: uctm10

GeobytesCertainty: 90

Here the field “GeobytesCity” contains the name of the city corresponding to the originating IP Address, in the present example being Brisbane. Similarly “GeobytesCountry” contains the name of the country in which web-browser 2 is located, in the present example being Australia. The HTTP_* format is used to store the result headers. For example, “GeobytesCity: Brisbane” is stored as HTTP_GEOBYTESCITY=Brisbane.

Server-side application 18 is then called by web-server 8. Data from request 4, along with the results of the information source's response are passed to server-side application 18 via interface 11. CGI application 18 is programmed to generate HTML document 12 that is tailored to the particular geographical location of web-browser 2 on the basis of the headers.

If CGI application 18 is written in PERL then it may contain a line of code like:

$City=$ENV{HTTP_GEOBYTESCITY}; to pass the value held in field “GeobytesCity” into the variable “City”.

It will be noted that server-side application 18 does not have to interact with information source 21 itself. Accordingly server-side application 18 does not have to be programmed to conform to any foreign (non-native) interface protocol, and is therefore not exposed to the overhead of establishing and interacting with such an interface.

This results in a reduced learning curve for developers wishing to access the geographic information and for improved efficiency and performance in servicing each web-browser request. Once HTML document 12 has been generated it is passed from the web-server application 18 back to web-server 8 and thence to browser 2. Browser 2 then displays HTML document 12 which is specifically tailored to reflect the geographical location of web-browser 2.

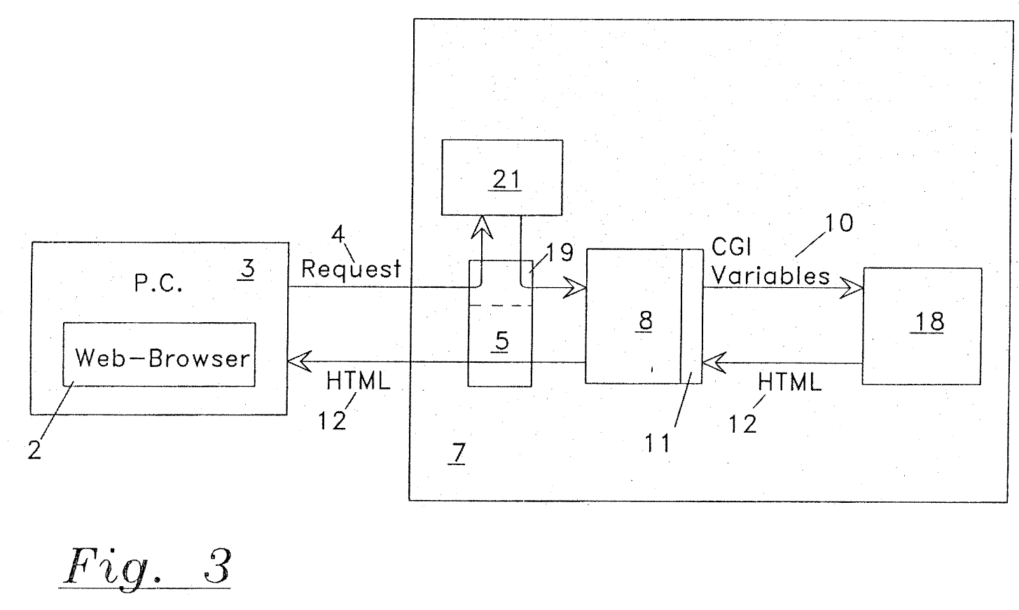

FIG. 3 depicts a further embodiment of the invention wherein communication between personal computer 3 and web-server application 8 is via a firewall application 5. Typically firewall applications are supported by hardware platforms that are physically distinct from the platform supporting web-server application 8. According to the embodiment of the invention shown in FIG. 3 preprocessing application 19 is an extension of firewall application 5. Where firewall application 5 is written to run on the open-source Linux operating system preprocessing application 19 is particularly straightforward to implement.

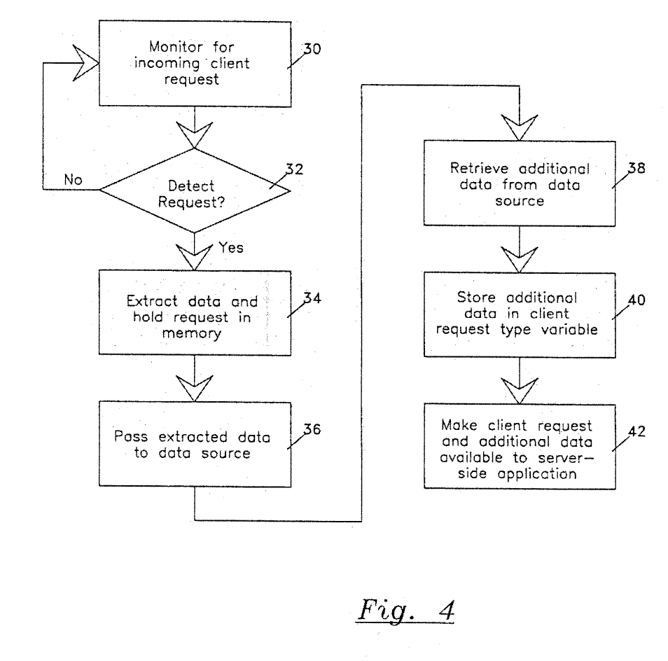

FIG. 4 is a flowchart of the steps of a method according to an embodiment of the present invention. Initially, at box 30 pre-processing application 19 monitors for incoming client requests. At box 32, upon a client request being detected control diverts to box 34 where the request is stored in memory and data from the request extracted. At box 36 the extracted data is passed to data source 21. At box 38 additional data, being the response from data source 21 is stored in client request-type variables. At box 42 the additional data and the client request data are made available to server-side application 18 by means of the web-server application's interface 11. The steps may be implemented as coded instructions in pre-processing application 19.

For example, pre-processing application 19 would typically include instructions for detecting a client request 4, instructions for generating additional data on the basis of information associated with client request 4 and instructions for storing the additional data in a format compatible with client request 4.

Although the invention has been described in the context of a data source and server-side application used to create HTML documents geographically appropriate to a particular web-browser request, it is generally applicable wherever it is desired to pass data to server-side scripts or applications. For example the present invention may be used to insert data pertaining to cookie information present in a browser request.

Although the present invention has been described in terms of preferred embodiment, it is not intended that the invention be limited to these embodiments. Equivalent methods, structures, arrangements, processes, steps and other modifications within the spirit of the invention fall within the scope of the invention described herein.

1. A method for passing pre-processed data to server-side applications, where a web-server platform runs a web-server application and one or more server-side applications and the web-server application interacts with said server-side applications by means of an interface separating client-side processes from server-side processes, the method comprising the steps of:
pre-processing a request from a remote client prior to data from the request being passed to the server-side applications via the interface;
generating additional data in response to said request at the client-side of said interface; and
making available the additional data to the one or more server-side applications in a format according to the interface.

2. A method as claimed in claim 1, in which the pre-processing step comprises running a pre-processing application on the web-server platform.

3. A method as claimed in claim 1, in which the pre-processing step comprises running a pre-processing application on a platform distinct from the web-server platform.

4. A method as claimed in claim 3, in which the pre-processing step comprises running the pre-processing application on a firewall platform interposed between the remote client and the web-server platform.

5. A method as claimed in claim 1, in which the pre-processing step includes the step of retrieving a geographical location from the data source corresponding to a network address associated with the request.

6. A method as claimed in claim 1, in which the step of generating the additional data is carried out by interaction with a data source application.

7. A computer system for responding to requests from a web-browser, the computer system supporting a web-server application and communicating with one or more server-side applications by means of a common interface, said computer system comprising:
at least one CPU;
at least one memory coupled to the at least one CPU; and
a pre-processing application resident in the memory and executed by the at least one CPU, the pre-processing application including instructions to generate additional data on the basis of the requests and to make the additional data available to the server-side applications by means of the common interface.

8. A computer system as claimed in claim 7, in which the pre-processing application comprises an extension of the web-server application.

9. A computer system as claimed in claim 7, in which the pre-processing application is configured to intercept the requests at an operating system level of the computer system.

10. A computer system as claimed in claim 7, in which the pre-processing application comprises an extension to a firewall application between the web-server application and the client browser.

11. A computer system as claimed in claim 7, in which the pre-processing application is configured to interact with a database.

12. A computer system as claimed in claim 11, in which the pre-processing application includes instructions for retrieving geographical locations from the data source corresponding to network addresses associated with the requests.

13. A software program product that is executable by a processor of a computer network device, the software program product comprising
instructions for detection of a client request containing data in a request format at a client side of the computer network device;
instructions for generating additional data on the basis of information associated with the client request; and
instructions for storing the additional data in the request format.

14. A software product as claimed in claim 13 in which the instructions for generating additional data include instructions for interfacing with a data source application.
